(19) United States
(12) Patent Application Publication
(10) Pub. No.: US 2004/0156300 A1
(43) Pub. Date: Aug. 12, 2004

(54) Optical pick-up apparatus and liquid crystal display device

(75) Inventor: Hiroyuki Shindo, Yokohama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/695,925

(22) Filed: Oct. 28, 2003

(30) Foreign Application Priority Data
Oct. 31, 2002 (JP) 2002-318888

(51) Int. Cl. G11B 7/135

(52) U.S. Cl. 369/112.02

(57) ABSTRACT

Disclosed herein is an optical pick-up apparatus. The apparatus for recording and reproducing information by radiating first or second laser lights onto first and second discs, respectively, the first disc for recording and reproducing information using the first laser light, the second disc for recording and reproducing information using the second laser light having a band of wavelengths different from that of the first laser light, includes a first liquid crystal display for correcting spherical aberration by acting on the first laser light, a second liquid crystal display for correcting coma aberration by acting on the second laser light having a polarization direction perpendicular to that of the first laser light, and an object lens. The first and second liquid crystal displays and the object lens are movably supported. Accordingly, a BD can be compatible with a DVD or CD in the optical pick-up apparatus.

### BACKGROUND OF THE INVENTION

1. Field of the Invention

The present invention relates to an optical pick-up apparatus and liquid crystal display device.

2. Description of the Prior Art

In an optical pick-up apparatus for a Blue-ray Disc (hereinafter referred to as a “BD”), an object lens for a BD is mounted in a lens holder generally suspended by four or six suspension wires, and a laser light having a wavelength of 405 nm is radiated onto the BD through the object lens for a BD. Additionally, a liquid crystal display is mounted in the lens holder to correct spherical aberration caused by an error in the thickness of a substrate of the BD. The liquid crystal display is generally provided with four electrodes, and a voltage is applied to the liquid crystal display through the four or six suspension wires.

In the case where a BD is compatible with a Digital Versatile Disc (DVD) in an optical pick-up apparatus for the DVD, a laser light having a wavelength of 655 nm is radiated onto a DVD through the object lens for a BD whose numerical aperture is 0.85. In this case, the numerical aperture of the object lens for a BD and the numerical aperture of an object lens for a DVD are different, so that a numerical aperture-limiting device depending on a wavelength is mounted in the lens holder. The numerical aperture-limiting device does not act on a laser light having a wavelength of 405 nm, and acts on the laser light having the wavelength of 655 nm, to set the numerical aperture of the object lens for a BD to 0.6. Additionally, in order to reduce spherical aberration of the laser light having the wavelength of 655 nm, the laser light is a diffuse light, what is called a finite system, incident on the object lens.

However, when the lens holder is shifted in a radial direction of the DVD to follow the eccentricity of the DVD because the laser light having the wavelength of 655 nm is a finite system, coma aberration is generated and an optical resolution is lowered. Accordingly, a liquid crystal display that corrects the coma aberration of the laser light having the wavelength of 655 nm needs to be mounted in the lens holder. However, the liquid crystal display that corrects the coma aberration needs three or more electrodes. Accordingly, in the case where a corresponding liquid crystal display is mounted in the lens holder, power is not supplied to the liquid crystal display through suspension wires. Although the problems of the optical pick-up apparatus for a DVD have been described in the above, similar problems are generated for the optical pick-up apparatus for a Compact Disc (CD).

### SUMMARY OF THE INVENTION

Accordingly, the present invention has been made keeping in mind the above problems occurring in the prior art, and an object of the present invention is to provide an optical pick-up apparatus, in which a BD is compatible with a DVD or CD.

In order to accomplish the above object, the present invention provides an optical pick-up apparatus for recording and reproducing information by radiating first or second laser lights onto first and second discs, respectively, the first disc for recording and reproducing information using the first laser light, the second disc for recording and reproducing information using the second laser light having a band of wavelengths different from that of the first laser light, including a first liquid crystal display for correcting spherical aberration by acting on the first laser light, a second liquid crystal display for correcting coma aberration by acting on the second laser light having a polarization direction perpendicular to that of the first laser light, and an object lens, wherein the first and second liquid crystal displays and the object lens are movably supported.

It is preferable that the object lens and the first and second liquid crystal displays are movably supported by a plurality of suspension wires, the first liquid crystal display is formed on a first surface of a first transparent substrate, the first liquid crystal display at least comprising a first transparent electrode, first orientation films, a liquid crystal and a second transparent electrode, which are inserted between a second transparent substrate and the first transparent substrate to correct spherical aberration, the second liquid crystal display is formed on a second surface of the first transparent substrate, the second liquid crystal display at least comprising a third transparent electrode, second orientation films, a liquid crystal and a fourth transparent electrode, which are inserted between a third transparent substrate and the first transparent substrate to correct coma aberration, and the first and third transparent electrodes are each formed of a plurality of electrodes, one or more pairs of electrodes being electrically connected to each other, one of the electrodes being the first transparent electrode, another of the electrodes being the third transparent electrode, and the second transparent electrode is electrically connected to the fourth transparent electrode.

Additionally, it is preferable that the object lens and the first and second liquid crystal displays are movably supported by a plurality of the suspension wires, and a drive voltage is supplied to the transparent electrodes through the suspension wires.

In order to accomplish the above object, the present invention provides a liquid crystal display device, including a first transparent substrate, a first liquid crystal display formed on a first surface of the first transparent substrate, the first liquid crystal display at least comprising a first transparent electrode, first orientation films, a liquid crystal and a second transparent electrode, which are inserted between a second transparent substrate and the first transparent substrate to correct spherical aberration, and a second liquid crystal display formed on a second surface of the first transparent substrate, the second liquid crystal display at least comprising a third transparent electrode, second orientation films, a liquid crystal and a fourth transparent electrode, which are inserted between a third transparent substrate and the first transparent substrate to correct coma aberration, wherein the first and third transparent electrodes each formed of a plurality of electrodes, one or more pairs of electrodes being electrically connected to each other, one of the electrodes being the first transparent electrode, another of the electrodes being the third transparent electrode, and the second transparent electrode is electrically connected to the fourth transparent electrode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view of a principal portion of an optical pick-up apparatus according to the first embodiment of the present invention;

FIG. 2 shows a section of a lens holder according to the first embodiment of the present invention;

FIGS. 3a to 3c are views of a construction of a liquid crystal display device according to the first embodiment of the present invention;

FIG. 4 is a detail view of the liquid crystal display device according to the first embodiment of the present invention;

FIG. 5 is a view of a construction of a laser light radiating/receiving unit according to the first embodiment of the present invention;

FIG. 6 is a view of a construction of a laser light radiating/receiving unit according to the second embodiment of the present invention; and

FIG. 7 is a view of a construction of a laser light radiating/receiving unit according to the third embodiment of the present invention.

### DESCRIPTION OF THE PREFERRED EMBODIMENTS

Reference now should be made to the drawings, in which the same reference numerals are used throughout the different drawings to designate the same or similar components.

Hereinafter, embodiments of an optical pick-up apparatus of the present invention will be described in detail with reference to the attached drawings.

First Embodiment

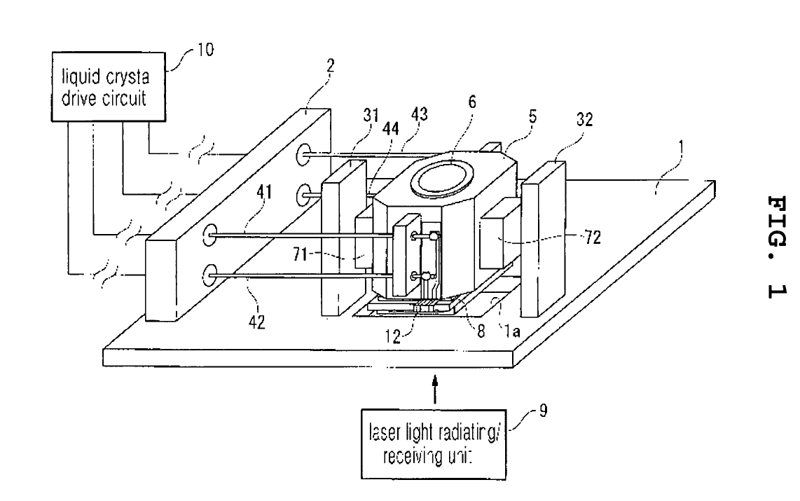

FIG. 1 is a view of a principal portion of an optical pick-up apparatus according to a first embodiment of the present invention. In the FIG. 1, reference numerals 1 and 2 designate a base unit and a wire support, respectively. Reference numerals 31 and 32 designate yoke coils, and reference numerals 41 to 44 designate suspension wires. Reference numerals 5 and 6 designate a lens holder and an object lens, respectively. Reference numerals 71 and 72 designate magnets. Reference numerals 8, 9 and 10 designate a liquid crystal display device, a laser light radiating/receiving unit, and a liquid crystal drive circuit, respectively.

The base unit 1 is formed into a plate shape, and an opening 1a, through which a laser light radiated from a laser light radiating/receiving unit 9 passes, is formed in the central portion of the base unit 1. The wire support 2 is formed into a roughly rectangular shape and is fixedly mounted in the left portion of the base unit 1.

The yoke coils 31 and 32 are supplied with current from an external drive unit, move the lens holder 5 in a radial direction or focusing direction, and are disposed on the base unit 1 with the opening la interposed therebetween. That is, the yoke coil 31 is disposed to the left of the opening la and the yoke coil 32 is disposed to the right of the opening 1a.

The suspension wires 41 to 44 are fixed to the lens holder 5 at their one ends, and additionally fixed to the wire support 2 at their second ends. That is, as shown in FIG. 1, the suspension wires 41 and 42 are supported by the wire support 2 in the front of the opening 1a to be parallel with the base unit 1, and the suspension wires 43 and 44 are supported by the wire support 2 in the back of the opening 1a to be parallel with the base unit 1. Additionally, the second terminal of each of the suspension wires 41 to 44 is connected to the liquid crystal drive circuit 10 that applies a voltage to the liquid crystal display device 8, that is, that outputs a liquid crystal drive signal.

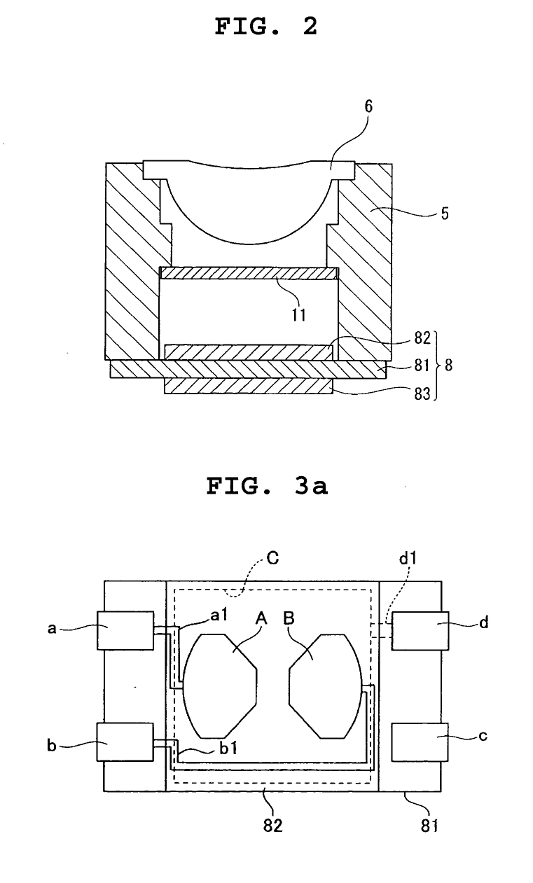

The lens holder 5 has a roughly hollow hexahedral shape and is positioned above the opening 1a to be moved by the second terminals of the suspension wires 41 to 44. FIG. 2 shows a section of the lens holder 5. As shown in FIG. 2, the object lens for a BD 6, whose numerical aperture is 0.85, is fitted into the upper portion of the lens holder 5, and a numerical aperture-limiting device 11 depending on a wavelength, which acts on a laser light having a wavelength of 655 nm (a second laser light) so that the numerical aperture of the object lens for a BD 6 is set to 0.6, is installed in the lens holder 5. Additionally, the liquid crystal display device 8 is mounted under the lens holder 5.

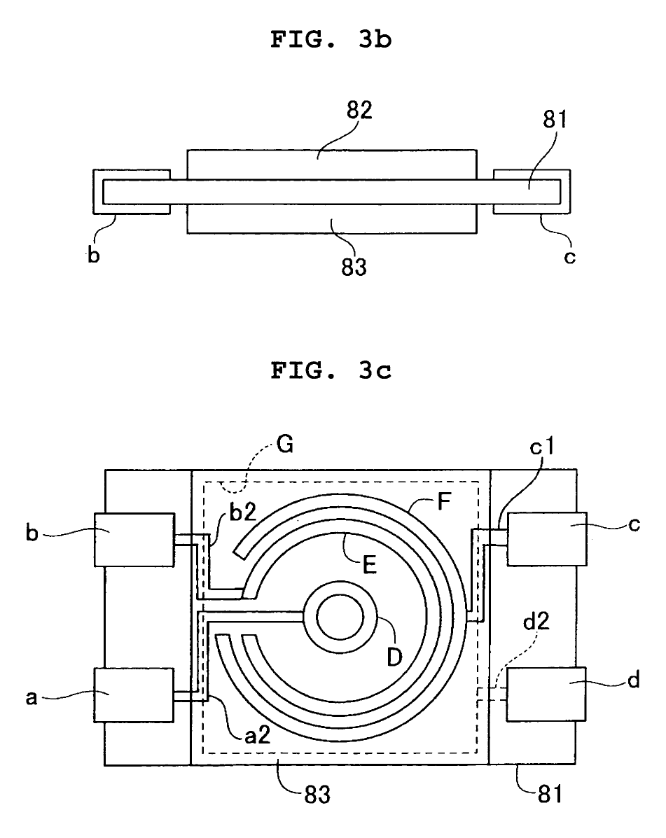

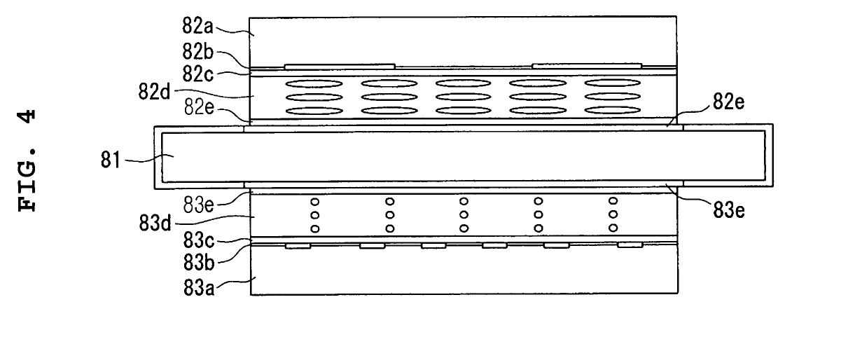

Referring to FIGS. 3 and 4, the liquid crystal display device 8 will be described. The liquid crystal display device 8 includes a transparent substrate 81 (a first transparent substrate), a coma aberration correcting liquid crystal display 82 (a second liquid crystal display) and spherical aberration correcting liquid crystal display 83 (a first liquid crystal display). The transparent substrate 81 is a transparent plate made of glass, and is provided with connection terminals a to d. On the lower surface of the transparent substrate 81, there is mounted the spherical aberration correcting liquid crystal display 83 that corrects spherical aberration by acting on a laser light polarized in a first direction. On the upper surface of the transparent substrate 81, there is mounted the coma aberration correcting liquid crystal display 82 that corrects coma aberration by acting on a laser light polarized in a second direction perpendicular to the first direction.

On the lower surface of the transparent substrate 81, there is mounted the spherical aberration correcting liquid crystal display 83 that corrects the spherical aberration by acting on the laser light polarized in the first direction. The spherical aberration correcting liquid crystal display 83 includes a transparent electrode 83b (a first transparent electrode), orientation films 83c (a first orientation film), a liquid crystal 83d and a transparent electrode 83e (a second transparent electrode), which are inserted between a transparent substrate 83a (a second transparent substrate) and the transparent substrate 81, to correct the spherical aberration. Specifically, in the FIG. 4, the liquid crystal 83d is injected and sealed between the transparent substrate 81 and the transparent substrate 83a positioned therebelow. When a voltage is applied to the spherical aberration correcting liquid crystal display 83, the liquid crystal 83d is oriented in the first direction of the laser light. Accordingly, when a voltage is applied to the spherical aberration correcting liquid crystal display 83, a refractive index detected by the laser light is changed in an area where the voltage is applied, which affects the phase of the laser light in the area. Accordingly, the spherical aberration is corrected by controlling the phase.

Meanwhile, on the upper surface of the transparent substrate 81, there is mounted the coma aberration correcting liquid crystal display 82 that corrects the coma aberration by acting on the laser light polarized in the second direction perpendicular to the first direction. The coma aberration correcting liquid crystal display 82 includes a transparent electrode 82b (a third transparent electrode), orientation films 82c (a second orientation film), a liquid crystal 82d and a transparent electrode 82e (a fourth transparent electrode), which are inserted between a transparent substrate 82a (a third transparent substrate) and the transparent substrate 81, to correct the coma aberration. Specifically, in the FIG. 4, the liquid crystal 82d is injected and sealed between the transparent substrate 81 and the transparent substrate 82a positioned thereabove. The liquid crystal 82d is oriented in a direction perpendicular to the orientation direction of the liquid crystal 83d of the spherical aberration correcting liquid crystal display 83. when a voltage is applied to the coma aberration correcting liquid crystal display 82, a refractive index detected by the laser light polarized in the second direction perpendicular to the first direction is changed in an area where the voltage is applied, which affects the phase of the laser light in the area. Accordingly, the coma aberration is corrected by controlling the phase.

Additionally, although the laser light polarized in the first direction passes through the area of the coma aberration correcting liquid crystal display 82 where the voltage is applied, the refractive index of the liquid crystal molecule is not changed and the phase of the laser light polarized in the first direction is not affected by the coma aberration correcting liquid crystal display 82, because the oriented direction of the molecules of the liquid crystal 82d in the area is perpendicular to the first polarization direction. Similarly to the operation described above, although the laser light polarized in the second direction perpendicular to the first direction passes through the spherical aberration correcting liquid crystal display 83, the phase of the laser light is not affected by the spherical aberration correcting liquid crystal display 83.

Accordingly, the phase of the laser light polarized in the first direction is affected by only the spherical aberration correcting liquid crystal display 83, and the phase of the laser light polarized in the second direction perpendicular to the first direction is affected by only the coma aberration correcting liquid crystal display 82.

Additionally, referring to FIGS. 3a to 3c and 4, the coma aberration correcting liquid crystal display 82 is mounted on the upper surface of the transparent substrate 81, and the spherical aberration correcting liquid crystal display 83 is mounted on the lower surface of the transparent substrate 81. However, the coma aberration correcting liquid crystal display 82 may be mounted on the lower surface of the transparent substrate 81, and the spherical aberration correcting liquid crystal display 83 may be mounted on the upper surface of the transparent substrate 81.

In the upper portion of the coma aberration correcting liquid crystal display 82, the transparent electrodes A and B (the transparent electrode 82b), as shown in FIG. 3a, are arranged with a light axis disposed therebetween so as to correct the coma aberration. The transparent electrode A is electrically connected to the connection terminal a through a transparent pattern al. The transparent electrode B is electrically connected to the connection terminal b through a transparent pattern bl. A transparent electrode C (the transparent electrode 82e) is mounted in the lower portion of the coma aberration correcting liquid crystal display 82, and the transparent electrode C is electrically connected to the connection terminal d through a transparent pattern d1.

In the lower portion of the spherical aberration correcting liquid crystal display 83 transparent electrodes D, E and F (the transparent electrode 83b), as shown in FIG. 3c, are positioned around the light axis to correct the spherical aberration. The transparent electrode D is electrically connected to the connection terminal a through a transparent pattern a2. The transparent electrode E is electrically connected to the connection terminal b through a transparent pattern b2. The transparent electrode F is electrically connected to the connection terminal c through a transparent pattern c1. A transparent electrode G (the transparent electrode 83e) is formed in the upper portion of the spherical aberration correcting liquid crystal display 83, and the transparent electrode G is electrically connected to the connection terminal d through a transparent pattern d2.

Referring back to FIG. 1, a Flexible Printed Circuit (FPC) 12 that electrically connects the suspension wires 41 and 42 to the connection terminals a and b, respectively, is attached by a tape, etc. in the front side of the lens holder 5. A FPC (not shown) that electrically connects the suspension wires 43 and 44 to the connection terminals c and d, respectively, is attached by a tape and so on in the back side of the lens holder 5. Since the FPCs positioned in the front and back side of the lens holder, the suspension wires 41 to 44 and the connection terminals a to d are fixed by a soldering process, the suspension wires 41 to 44 and the connection terminals a to d may be electrically connected to each other.

The magnets 71 and 72 are each attached to the side surface of the lens holder 5. That is, the magnet 71 is attached to the side surface of the lens holder 5 facing the yoke coil 31, and the magnet 72 is attached to the side surface of the lens holder 5 facing the yoke coil 32. That is, the magnets 71 and 72 receive force caused by a current flowing through the yoke coils 31 and 32, and move the lens holder 5 in the up and down direction (the focusing direction) or the radial direction.

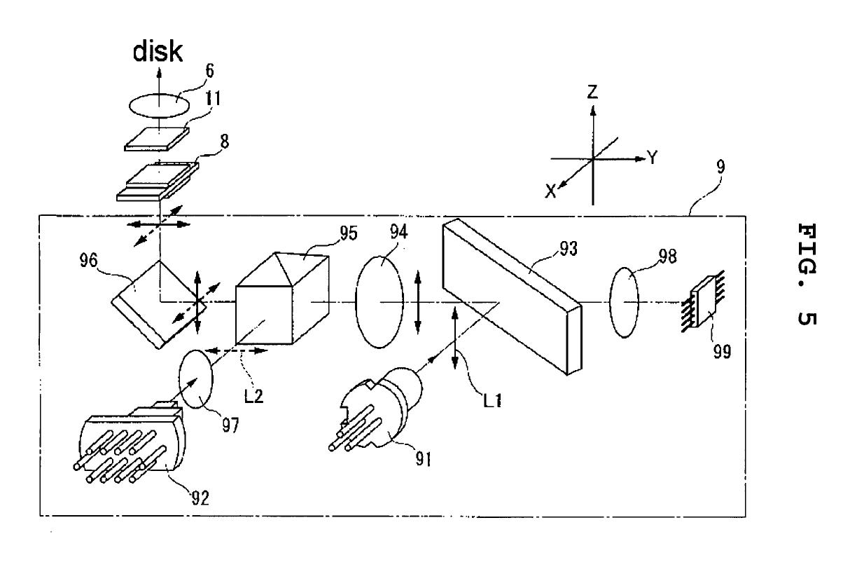

Below the opening 1a, there is positioned the laser light radiating/receiving unit 9 that radiates one of a laser light polarized in the first direction and having a wavelength of 405 nm (hereinafter referred to as a “blue laser light L1”) and a laser light polarized in the second polarization direction and having a wavelength of 655 nm (hereinafter referred to as a “red laser light L2”) toward the object lens for a BD 6. The laser light radiating/receiving unit 9 will be described in detail with reference to FIG. 5.

FIG. 5 is a view of a construction of the laser light radiating/receiving unit 9 according to the first embodiment of the present invention. In FIG. 5, reference numerals 91, 92, 93, 94, 95, 96, 97, 98 and 99 designate a semiconductor laser for a BD, a hologram laser unit for a DVD, a beam splitter, a collimer lens, a dichroic prism, a standing mirror, a coupling lens, a detection lens and a detector, respectively.

The semiconductor laser for a BD 91 radiates the blue laser light L1, which is polarized in a Z direction, in an X direction. The beam splitter 93 reflects the blue laser light L1 radiated from the semiconductor laser for a BD 91 toward the collimer lens 94, that is, the beams splitter 93 reflects the blue laser light L1 in a Y direction, and additionally, passes the blue laser light L1 incident in the Y direction therethrough. The collimer lens 94 converts the blue laser light L1 reflected from the beam splitter 93 into a parallel ray and radiates it toward the dichroic lens 95, and additionally radiates the blue laser light L1 reflected from a BD and then passed through the dichroic lens 95 toward the beam splitter 93. The dichroic prism 95 is provided with a reflected surface, which is made of multiple dielectric layers that pass the blue laser light L1 incident in the Y direction, reflect a red laser light L2 incident in the X direction in the Y direction, and reflect a red laser light L2 incident in the Y direction in the X direction. The standing mirror 96 reflects the laser light radiated from the dichroic prism 95, that is, a laser light incident in the Y direction, in the Z direction, and then outputs it to the outside of the laser light radiating/receiving unit 9, that is, allows it to be incident on the liquid crystal display device 8.

The hologram laser unit for a DVD 92 radiates the red laser light L2, which is polarized in the Y direction, in the X direction, receives the red laser light L2 reflected from a DVD, and outputs it to the outside of the laser light radiating/receiving unit 9 as an information reproduction signal of the disc, or an error signal for focusing or tracking. The coupling lens 97 allows a diffusion angle of the red laser light L2 radiated from the hologram laser unit for a DVD 92 to be small, and radiates it toward the dichroic prism 95.

The detection lens 98 collects the laser light passing through the beam splitter 93, and radiates it toward the detector 99. The detector 99 receives the blue laser light L1 collected by the detection lens 98, and outputs it to the outside of the laser light radiating/receiving unit 9 to be used as an information reproduction signal of the disc or error signal for focusing or tracking.

Thereafter, there will be described the operation of the optical pick-up apparatus of the first embodiment, which is constructed as described above.

There will be described the operation of the optical pick-up apparatus with respect to a BD. A laser light L1 polarized in the Z direction, which is radiated from the semiconductor laser for a BD 91, is reflected in the Y direction by the beam splitter 93 and is then incident on the collimer lens 94. Thereafter, the blue laser light L1 becomes a parallel ray by the collimer lens 95 and then passes through the dichroic prism 95. Thereafter, the blue laser light L1 is reflected in the Z direction by the standing mirror 96. As a result, the polarization direction of the blue laser light L1 is changed to the Y direction. In this case, the blue laser light L1 is incident on the liquid crystal display device 8. In brief, the laser light radiated/receiving 9 radiates the blue laser light L1 polarized in the Y direction toward the liquid crystal display device 8.

The liquid crystal display device 8 receives a liquid crystal drive signal from the liquid crystal drive circuit 10 through the suspension wires 41 to 44. That is, voltages with the same amplitude are applied to the transparent electrodes A and D through the connection terminal a, respectively, voltages with the same amplitude are applied to the transparent electrodes B and E through the connection terminal b, respectively, a voltage is applied to the transparent electrode F through the connection terminal c, and voltages with the same amplitude are applied to the transparent electrodes C and G through the connection terminal d, respectively. As described above, the spherical aberration correcting liquid crystal display 83 acts on the laser light polarized in the first direction, that is, the blue laser light L1, by the application of a voltage. The first direction is the Y direction that is polarization direction of the blue laser light L1. In contrast, the coma aberration correcting liquid crystal display 82 acts on a laser light polarized in the X direction, that is, the red laser light L2.

Since the blue laser light L1 radiated from the laser light radiating/receiving unit 9 and then incident on the liquid crystal display device 8 is polarized in the Y direction, spherical aberration caused by an error in the thickness of a substrate of the BD is corrected by the spherical aberration correcting liquid crystal display 83 when the blue laser light L1 is radiated onto the BD.

The blue laser light L1 passes through the transparent substrate 81 and the coma aberration correcting liquid crystal display 82, and is incident onto the inside of the lens holder 5. In this case, the coma aberration correcting liquid crystal display 82 does not act on the blue laser light L1.

The blue laser light L1 is incident on the object lens for a BD 6 whose numerical aperture is 0.85. Additionally, the blue laser light L1 passes through the numerical aperture-limiting device 11 disposed inside the lens holder 5, but the numerical aperture-limiting device 11 only acts on a light having a wavelength of 655 nm, so that the blue laser light L1 is not affected and passes through the numerical aperture-limited device 11.

Additionally, the blue laser light L1 is collected by the object lens for a BD 6 and is then radiated onto the BD. The blue laser light L1 reflected from the BD returns to the beam splitter 93 along the same path described above. In this case, since the beam splitter 93 allows a laser light polarized in the Y direction to pass therethrough, the blue laser light L1 passes through the beam splitter 93 and is then incident on the detection lens 98. The blue laser light L1 is collected by the detection lens 98, converted into an information reproduction signal of the disc or error signal for focusing or tracking by the detector 99, and output to the outside of the laser light radiating/receiving unit 9.

Thereafter, there will be described the operation of the optical pick-up apparatus with respect to a DVD. The diffusion angle of the red laser light L2, polarized in the Y direction and radiated from the hologram laser unit for a DVD 92, becomes small by the coupling lens 97, and the red laser light L2 is incident on the dichroic prism 95. In this case, the reason that the red laser light L2 is not allowed to become a parallel ray is to reduce the spherical aberration caused by the object lens for a BD 6. The red laser light L2 incident on the dichroic prism 95 is reflected in the Y direction. As a result, the polarization direction of the red laser light L2 is changed to the X direction. Thereafter, the red laser light L2 is reflected in the Z direction and is then incident on the liquid crystal display device 8.

Since the red laser light L2 incident on the liquid crystal display device 8 is polarized in the X direction, the red laser light L2 passes through the spherical aberration correcting liquid crystal display 83 and the transparent substrate 81, and the coma aberration caused by the object lens for a BD 6 is corrected by the coma aberration correcting liquid crystal display 82 when the red laser light L2 is radiated onto the DVD.

The red laser light L2 is incident onto the inside of the lens holder 5, and the numerical aperture of the object lens for a BD 6 is set to 0.6 by the numerical aperture-limiting device 11. Thereafter, the red laser light L2 is collected by the object lens for a BD 6 and is then radiated on the DVD.

The red laser light L2 reflected from the DVD returns to the hologram laser unit for a DVD 92 along the same path described above. The red laser light L2 is converted into an information reproduction signal of the disc or error signal for focusing or tracking by the hologram laser unit for a DVD 92, and output to the outside of the laser light radiating/receiving unit 9.

That is, according to the first embodiment, the coma aberration correcting liquid crystal display 82 only acts on the red laser light L2, and the spherical aberration correcting liquid crystal display 83 only acts on the blue laser light L1. Accordingly, a voltage is applied to each of the transparent electrodes A and D through the suspension wire 41, a voltage is applied to each of the transparent electrodes B and E through the suspension wire 42, a voltage is applied to the transparent electrode F through the suspension wire 43, and a voltage is applied to each of the transparent electrodes C and G through the suspension wire 44. That is, power is supplied to the coma aberration correcting liquid crystal display 82 and the spherical aberration correcting liquid crystal display 83 using the four suspension wires 41 to 44, so that a BD is compatible with a DVD or CD in the optical pick-up apparatus according to the first embodiment.

Second Embodiment

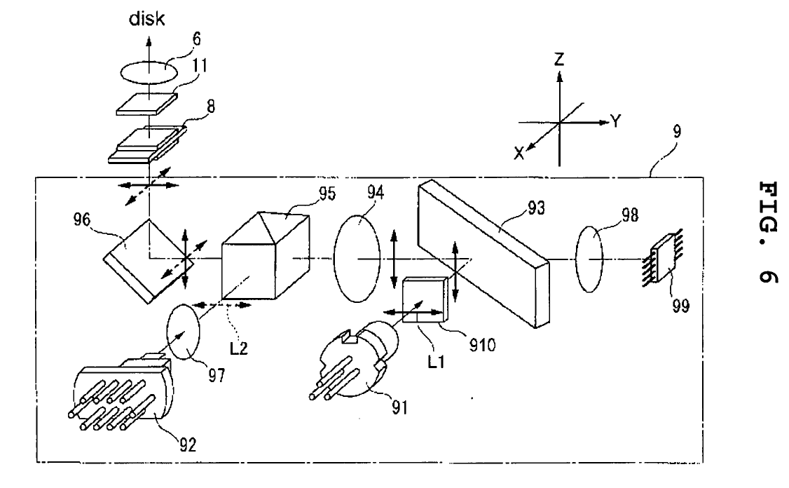

FIG. 6 shows the construction of the laser light radiating/receiving unit 9 according to the second embodiment of the present invention. In the second embodiment, as shown in FIG. 6, the blue laser light L1 and the red laser light L2 radiated from the semiconductor for a BD 91 and the hologram laser unit for a DVD 92, respectively, are polarized in the Y direction. To embody the optical pick-up apparatus according to the second embodiment, the laser light radiating/receiving unit 9 is provided with a half wavelength plate 910.

The half wavelength plate 910 changes the polarization direction of the blue laser light L1 by 90 degrees, and is disposed between the semiconductor laser for a BD 91 and the beam splitter 93. The construction and operation of the optical pick-up apparatus of the second embodiment is similar to those of the optical pickup apparatus of the first embodiment. However, since the blue laser light L1 radiated from the semiconductor for a BD 91 is polarized in the Y direction, the major elliptical axis of the mode field pattern of the blue laser light L1 is set to the Z direction, and the minor axis of a spot on the disc is set to the Y direction, that is, a tangential direction.

That is, according to the second embodiment, the minor axis of the spot on the disc can be set to the tangential direction, and the track information of the BD can be precisely reproduced in addition to the effects of the first embodiment.

Third Embodiment

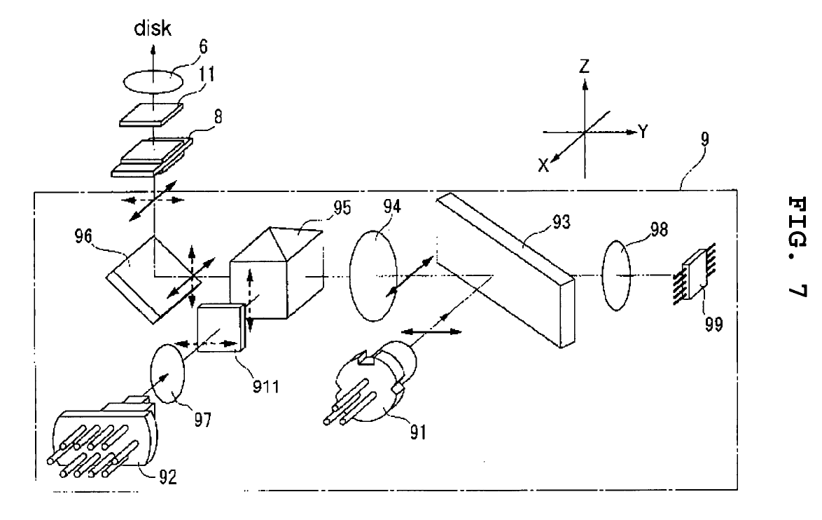

FIG. 7 shows the construction of the laser light radiating/receiving unit 9 according to a third embodiment of the present invention. In the third embodiment, as shown in FIG. 7, the blue laser light L1 and the red laser light L2 radiated from the semiconductor laser for a BD 91 and the hologram laser unit for a DVD 92, respectively, are polarized in the Y direction. To embody the optical pick-up apparatus according to the third embodiment, the laser light radiating/receiving unit 9 is provided with a half wavelength plate 911.

The half wavelength plate 911 changes the polarization direction of the red laser light L2 by 90 degrees, and is disposed between the coupling lens 97 and the dichroic prism 95. In this case, since the blue laser light L1 radiated from the semiconductor for a BD 91 is polarized in the Y direction, the minor axis of a spot on the disc is set to a tangential direction.

However, in this case, as shown in FIG. 7, the polarization direction of the blue and red laser lights incident on the liquid crystal display device 8 is changed by 90 degrees, so that the arrangement of the liquid crystal inside the coma aberration correcting liquid crystal display 82 and the spherical aberration correcting liquid crystal display 83 need to be rotated by 90 degrees.

That is, according to the third embodiment, the minor axis of the spot on the disc is set to the tangential direction other than effect of the first embodiment, and the track information of the BD can be precisely reproduced.

Additionally, the present invention is not limited to the first to third embodiments, and can be changed according to the following examples (1) to (3).

(1) In the first to third embodiments, four suspension wires 41 to 44 are used. However, six suspension wires can be used. In this case, the electrode patterns A to G each receive a liquid crystal drive signal from the corresponding suspension wire.

(2) In the first to third embodiments, a BD is compatible with a DVD in the optical pick-up apparatus. Additionally, a BD is compatible with a CD in the optical pick-up apparatus.

(3) In the first to third embodiments, suspension wires 41 and 42 and the connection terminals a and b are electrically connected to each other by the FPC 12, and the suspension wires 43 and 44 and the connection terminals c and d are electrically connected to each other by the FPC (not shown).

As described above, according to the present invention, the optical pick-up apparatus for recording and reproducing information by radiating first or second laser lights onto first and second discs, respectively, the first disc for recording and reproducing information using the first laser light, the second disc for recording and reproducing information using the second laser light having a band of wavelengths different from that of the first laser light, includes a first liquid crystal display for correcting spherical aberration by acting on the first laser light, a second liquid crystal display for correcting coma aberration by acting on the second laser light having a polarization direction perpendicular to that of the first laser light, and an object lens. The first and second liquid crystal displays and the object lens are movably supported. Accordingly, a BD can be compatible with a DVD or CD in the optical pick-up apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pick-up apparatus for recording and reproducing information by radiating first or second laser lights onto first and second discs, respectively, the first disc for recording and reproducing information using the first laser light, the second disc for recording and reproducing information using the second laser light having a band of wavelengths different from that of the first laser light, comprising:
a first liquid crystal display for correcting spherical aberration by acting on the first laser light;
a second liquid crystal display for correcting coma aberration by acting on the second laser light having a polarization direction perpendicular to that of the first laser light; and
an object lens;
wherein the first and second liquid crystal displays and the object lens are movably supported.

2. The optical pick-up apparatus according to claim 1, wherein:
the first liquid crystal display and the second liquid crystal display are respectively formed on each surface of a first transparent substrate;
the first liquid crystal display at least comprising a first transparent electrode, first orientation films, a liquid crystal and a second transparent electrode, which are inserted between a second transparent substrate and the first transparent substrate to correct spherical aberration;
the second liquid crystal display is formed on a second surface of the first transparent substrate, the second liquid crystal display at least comprising a third transparent electrode, second orientation films, a liquid crystal and a fourth transparent electrode, which are inserted between a third transparent substrate and the first transparent substrate to correct coma aberration; and
the first and third transparent electrodes are each formed of a plurality of electrodes, one or more pairs of electrodes being electrically connected to each other, one of the electrodes being the first transparent electrode, another of the electrodes being the third transparent electrode, and the second transparent electrode is electrically connected to the fourth transparent electrode.

3. The optical pick-up apparatus according to claim 2, wherein the object lens and the first and second liquid crystal displays are movably supported by a plurality of the suspension wires.

4. The optical pick-up apparatus according to claim 3, wherein a drive voltage is supplied to the transparent electrodes through the suspension wires.

5. The optical pick-up apparatus according to claim 1, wherein the object lens and the first and second liquid crystal displays are movably supported by a plurality of the suspension wires.

6. The optical pick-up apparatus according to claim 5, wherein a drive voltage is supplied to the transparent electrodes through the suspension wires.
